(19) United States
(12) Patent Application Publication
(10) Pub. No.: US 2007/0232241 A1
(43) Pub. Date: Oct. 4, 2007

(54) RF transceiver switching system

(75) Inventors: L. Richard Carley, Sewickley, PA (US); Emmanouil Metaxakis, Vrilissia-Athens (GR); Apostolos Samelis, Vrilissia-Athens (GR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Renaissance Wireless, Somerset, NJ (US)

(21) Appl. No.: 11/712,209

(22) Filed: Feb. 28, 2007

Related U.S. Application Data
(60) Provisional application No. 60/777,473, filed on Feb. 28, 2006.

(51) Int. Cl. H04B 1/44

(52) U.S. Cl. 455/83

(57) ABSTRACT

The present invention relates to transceiver systems and methods which employ shunt switches during transmit and receive operating modes. The shunt switches may be configured with various reactive networks to achieve high or low impedance states at power amplifiers or low noise amplifiers in order to reflect or transmit power along a given path. The shunt switches are designed for protection against excessive voltage swings that would otherwise damage components in the transceiver switching circuit. The switching circuits may be implemented in a single chip architecture, which results in manufacturing efficiencies, lower cost and higher reliability circuits. Single or multi band devices may also be employed.

### CROSS-REFERENCE TO RELATED APPLICATIONS

This application claims the benefit of the filing date of U.S. Provisional Patent Application No. 60/777,473 filed Feb. 28, 2006 and entitled “A Narrow Band BiCMOS Transmit Receive Switching Scheme for use in Radio Frequency Transceivers,” the entire disclosure of which is hereby incorporated by reference herein.

### BACKGROUND OF THE INVENTION

The present invention relates to electronic circuits that are radio frequency (“RF”) transceivers; in particular at different times the circuit is required to either transmit RF power to an antenna port or to receive RF power from the antenna port and amplify the signal in a low noise amplifier (“LNA”) on one or more separate frequency bands.

In recent years the use of wireless communications systems has increased significantly. Cellular and cordless telephone systems are ubiquitous. Portable wireless data devices are indispensable to many businesspeople and can be used to send and receive e-mails, surf the Internet and perform location based services. And fixed wireless local area networks (“LANs”) are becoming more and more popular as ongoing development increases the throughput rate of the systems. While such wireless communications systems may use different technologies to meet the needs of various applications and customers, all of them employ RF transceivers to send and receive information. Thus, more and more transceivers are being developed as the wireless marketplace expands.

FIG. 7 illustrates a block diagram of a high level system architecture for an RF front end 10 of a conventional transceiver (“Tx”). In particular, the RF front end 10 includes an antenna 12 that is coupled to both a transmit section 14 and a receive section 16. The transmit section 14 includes a power amplifier (“PA”) 18 and PA output matching circuitry 20, which are employed when transmitting information via the antenna 12. Similarly, the receive section 16 includes a low noise amplifier (“LNA”) 22 and LNA matching circuitry 24, which takes a received signal from the antenna 12 and provides an amplified version of the signal to the user device (not shown).

For many power amplifiers 18, the transmitted signal at the antenna 12 must be matched to a 50 ohm impedance level, which represents the impedance of the antenna 12. Normal transmit powers for common devices such as cell phones and wireless LAN devices are in the 100s of mW to 1 or more Watts. This means that large voltage swings exist at the antenna of these devices.

In order to switch high voltages with low RF attenuation of the signal, special devices such as GaAs high electron mobility transistor (“HEMT”) switches (including “DPHEMPT” switches) or Silicon on Saphire (“SOS”) switches are typically employed. PIN diodes have also been used for this application, but they have the drawback that they draw significant current whereas the aforementioned SOS and HEMT technologies do not draw significant current. Note that none of the aforesaid technologies widely used to implement the transmit/receive switches shown in FIG. 7 are easily integrated with advanced CMOS or BiCMOS IC processes. In contrast, such architectures may require a multi-chip solution or may require a multilayer laminated ceramic board in order to provide the necessary circuitry. Such multi-chip or multilayer laminates can have high manufacturing costs and reliability issues, rendering them undesirable for many applications.

In the past, researchers have sought ways to integrate the transmit/receive switch function into standard CMOS or BiCMOS IC processes. At low power levels, a low voltage MOS switch is capable of implementing this function. In addition, there have been several researchers who demonstrated the use of floating MOS switches in which breakdown of the switch to the substrate is avoided by using MOS devices in a CMOS well and then resonating the well to substrate capacitance at the frequency of the transmit signal. See, e.g., Feng-Jung Huang and Kenneth K. O, “Single-Pole Double-Throw CMOS Switches for 900-MHz and 2.4-GHz Applications on p⁻ Silicon Substrate,” IEEE Journal of Solid-State Circuits, Vol. 39, No. 1, January 2004; and Niranjan A. Talwalkar, C. Patrick Yue, Haitao Gan, and S. Simon Wong, “Integrated CMOS Transmit-Receive Switch Using LC-Tuned Substrate Bias for 2.4-GHz and 5.2-GHz Applications,” IEEE Journal of Solid-State Circuits, Vol. 39, No. 6, June 2004. However, all of these approaches create a large voltage stress either between the substrate and the well or between the well and the source and drain junctions. This can damage or destroy the switch, thereby rendering the transceiver inoperable. Therefore, the long term reliability of these approaches is questionable.

Thus, there is a need to provide transceiver switching solutions which address these and other issues.

### SUMMARY OF THE INVENTION

The instant application provides a system and method of creating a transmit/receive switch function using a BiCMOS or CMOS IC process, which allows for a single chip architecture. This includes silicon-based MOS and BJT transistor shunt switches and silicon diode-based shunt switches preferably formed using CMOS or BiCMOS technology. Such shunt switch devices are not required to withstand the voltage swings found at the antenna of the device in FIG. 1. Critical advantages of this solution are that it results in a lower cost, more robust solution with a higher level of integration for RF transceiver front ends.

In accordance with one embodiment of the present invention, a transceiver module is provided. The module comprises an antenna node, a transmit path, a receive path and at least one switchable impedance. The transmit path is electrically connected to the antenna node and comprises a power amplifier. The receive path is electrically coupled to the antenna node and comprises a low noise amplifier. The switchable impedance comprises a switch electrically coupled to the transmit path and the receive path. The switchable impedance is configured to switch between a first state that substantially reflects power in the transmit path from the antenna node and a second state that substantially reflects power in the receive path from the antenna node. The switch is a silicon based shunt switch coupled to ground and is selected from the group consisting of a silicon-based MOS switch, a silicon-based bipolar switch and a silicon-based diode. Furthermore, the transceiver module is formed on a single, unitary substrate.

In accordance with another embodiment of the present invention, a transceiver module comprises an antenna node, a transmit path, a receive path and at least one switchable impedance means. The transmit path is electrically connected to the antenna node and comprises a power amplifier. The receive path is electrically coupled to the antenna node and comprises a low noise amplifier. The switchable impedance means comprising switch means electrically coupled to the transmit path and the receive path. The switchable impedance means is configured to switch between a first state that substantially reflects power in the transmit path from the antenna node and a second state that substantially reflects power in the receive path from the antenna node. The transceiver module is formed on a single, unitary substrate.

In accordance with yet another embodiment of the present invention, a transceiver module comprising an antenna node, a frequency multiplexer and a plurality of transceivers is provided. The frequency multiplexer is coupled to the antenna node and the plurality of transceivers is each coupled to the antenna node via the frequency multiplexer. Each transceiver is configured to operate at a separate frequency, and each transceiver comprises a transmit path and a receive path. The transmit path is electrically connected to the antenna node. The transmit path comprises a power amplifier and at least one switchable impedance. The receive path is electrically coupled to the antenna node. The receive path comprises a low noise amplifier and at least one switchable impedance. Each switchable impedance is configured to switch between a first state that substantially reflects power back toward the antenna node and a second state in which signal power is transmitted along its respective path and comprising a switch. The switch is a silicon based shunt switch coupled to ground and is selected from the group consisting of a silicon-based MOS switch, a silicon-based bipolar switch and a silicon-based diode. Furthermore, the transceiver module is formed on a single, unitary substrate.

In accordance with a further embodiment of the present invention, a transceiver module comprising an antenna node, a transmit path and a receive path is provided. The transmit path is electrically connected to the antenna node. The transmit path comprises a power amplifier, a transformer coupled to the power amplifier, and a switchable impedance coupled to the transformer. The switchable impedance is in a high impedance state in a first mode of operation that is a receive mode and is in a low impedance state in a second mode that is a transmit mode. The receive path is electrically coupled to the antenna node. The receive path comprises a low noise amplifier and a switchable impedance that is in a high impedance state in the receive mode and a low impedance state in the transmit mode. Each switchable impedance comprises a silicon based shunt switch coupled to ground and is selected from the group consisting of a silicon-based MOS switch, a silicon-based bipolar switch and a silicon-based diode. Furthermore, the transceiver module is formed on a single, unitary substrate.

### BRIEF DESCRIPTION OF THE DRAWINGS

FIG. 1(a) illustrates a transceiver switching circuit in accordance with aspects of the present invention.

FIG. 1(b) illustrates a multi-band transceiver switching circuit in accordance with aspects of the present invention.

FIGS. 1(c)-1(m) illustrates reactive networks for use in transceiver switching circuits in accordance with aspects of the present invention.

FIG. 2 illustrates a transceiver switching circuit in accordance with aspects of the present invention.

FIG. 3 illustrates another transceiver switching circuit in accordance with aspects of the present invention.

FIG. 4 illustrates a further transceiver switching circuit in accordance with aspects of the present invention.

FIG. 5 illustrates yet another transceiver switching circuit in accordance with aspects of the present invention.

FIG. 6 illustrates another transceiver switching circuit in accordance with aspects of the present invention.

FIG. 7 illustrates an exemplary RF front end architecture.

FIGS. 8(a)-8(f) illustrate shunt switch types for use in the present invention.

### DETAILED DESCRIPTION

In describing the preferred embodiments of the invention illustrated in the appended drawings, specific terminology will be used for the sake of clarity. However, the invention is not intended to be limited to the specific terms used, and it is to be understood that each specific term includes all technical equivalents that operate in a similar manner to accomplish a similar purpose.

The present invention does not involve overall transceiver system architecture design, but rather addresses transceiver switching circuitry that may be employed in different transceiver architectures. A generalized discussion of transceiver architecture design may be found in “Transceiver System Design for Digital Communications,” by Scott R. Bullock, ©1995, ISBN 1-884932-40-0, the entire disclosure of which is hereby expressly incorporated by reference herein.

One of the critical issues addressed by the present invention involves avoiding high voltage swings that can occur during operation of an RF transceiver. As explained above, excessive voltages can adversely affect transceiver components, causing degradation in performance or even overall system failure.

While embodiments of the present invention employ MOS, BJT or diode switches in the transceiver, it is very important to avoid subjecting them to a high voltage stress. According to one aspect of the invention, this can be done by using shunt switches to reflect or transmit power across the transmitter or receiver portions of the transceiver as needed. That is, switches are connected to a low RF swing node and are in their low impedance state during the transmit operation.

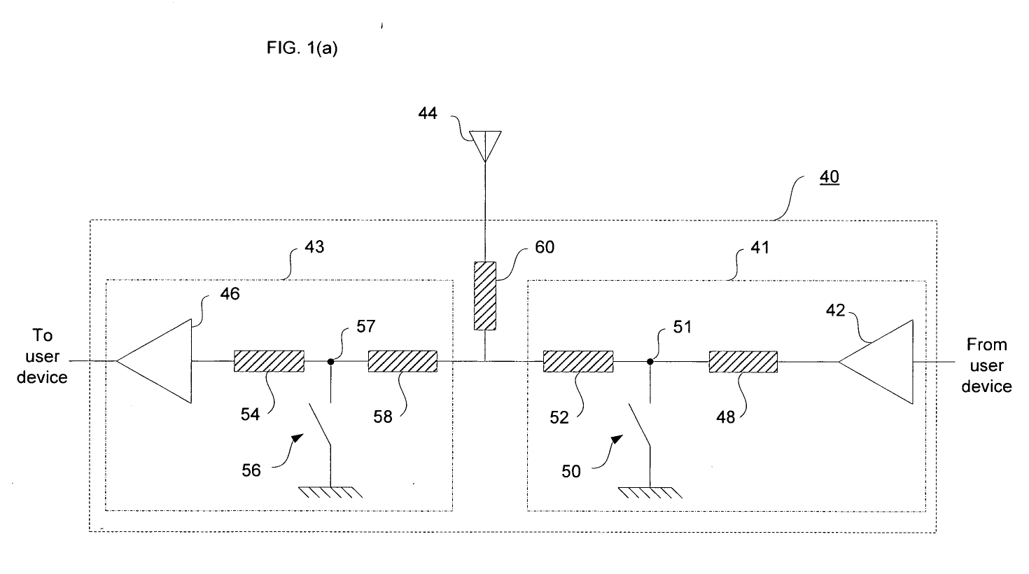

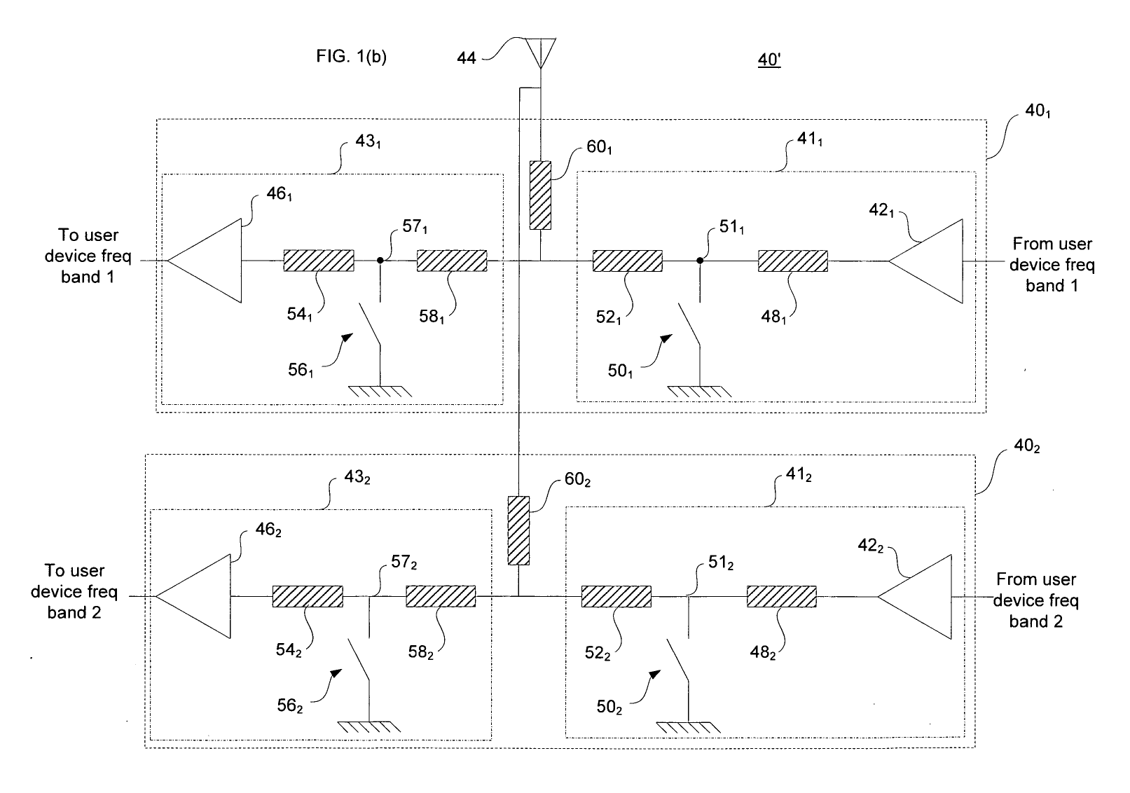

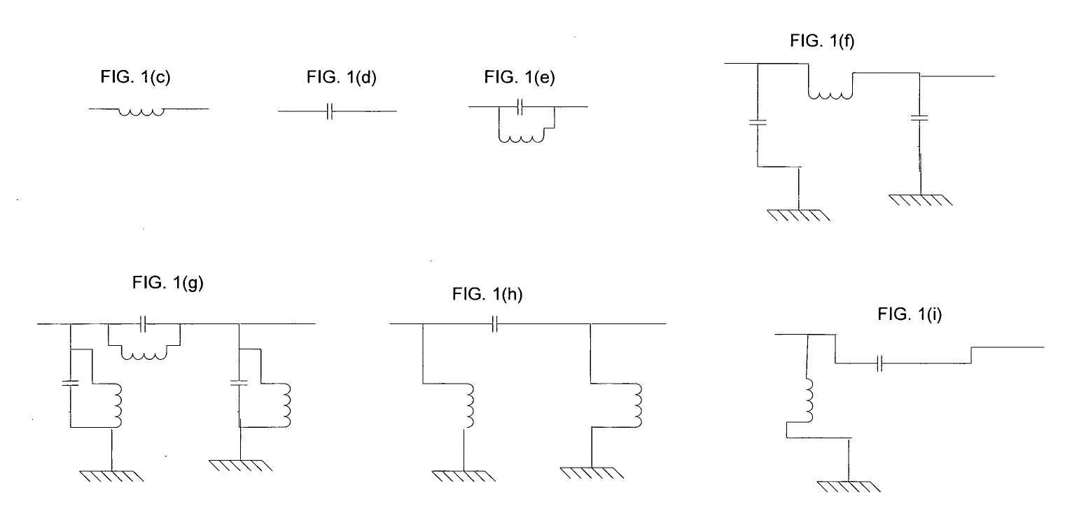

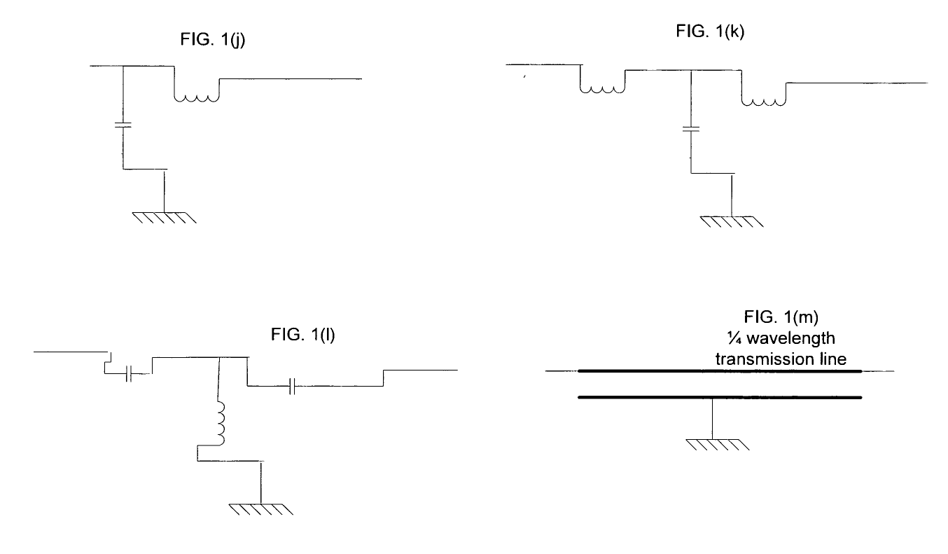

FIG. 1(a) illustrates a general architecture for a transceiver switching circuit 40. The circuit 40 includes a power amplifier section 42 operable to receive signals from a user device (not shown) coupled thereto. The power amplifier section 42 is coupled to antenna 44 and is further operable to transmit the signals received from the user device using the antenna 44. The circuit 40 also includes a low noise amplifier section 46 that is coupled as well to both the antenna 44 and the user device. The LNA section 46 receives input signals from the antenna 44, amplifies them, and sends the amplified signals to the user device.

Preferably electrically coupled between the PA section 42 and the antenna 44 are a first reactive device 48, a shunt switch 50 and a second reactive device 52, and preferably electrically coupled between the LNA section 46 and the antenna 44 are a third reactive device 54, a shunt switch 56, and a fourth reactive device 58. Another reactive device 60 may also be electrically coupled between the antenna 44 and the PA section 42 and the LNA section 46 as shown, for example to help provide impedance matching with the antenna 44 or for protection against electrostatic discharge at input or output pins. While the reactive devices 48, 52, 54, 58 and 60 are shown, any or all of these devices may be omitted in a particular design.

The reactive devices 48, 52, 54, 58 and 60 are most preferably formed as reactive networks, which may include various combinations of capacitors, inductors and transmission lines. Such reactive networks may be constructed to achieve a predetermined impedance at one or more frequencies. Preferably, the reactive networks are selected or adjusted to maximize power transfer along the path from the antenna to the receiver in receive mode and along the path from the transmitter to the antenna in the transmit mode. The specific configurations of reactive networks are not critical to the invention, and may be selected based on engineering design parameters. Nonetheless, several specific reactive network configurations are illustrated in FIGS. 1(c)-1(m) by way of example only. For instance, FIGS. 1(c), 1(d) and 1(e) illustrate an inductor, a capacitor, and a parallel inductor/capacitor configuration. FIG. 1(f) illustrates a high pass “pi” impedance matching network, FIG. 1(g) illustrates a bandpass pi impedance matching network and FIG. 1(h) illustrates a lowpass pi impedance matching network. FIG. 1(i) illustrates a highpass “L” matching network and FIG. 1(j) illustrates a lowpass L matching network. FIG. 1(k) illustrates a lowpass “T” matching network and FIG. 1(l) illustrates a highpass T matching network. FIG. 1(m) illustrates a quarter wave transmission line reactive device. Other reactive network configurations may be found in the text “RF Circuit Design,” by Chris Bowick, ©1982, ISBN 0-7506-9946-9, the entire disclosure of which is hereby expressly incorporated by reference herein.

Returning to FIG. 1(a), the greatest danger that may occur to the switches 50 and 56 due to high voltage swings will typically be during transmit mode. While the shunt switches 50 and 56 are shown as connecting at one end, respectively, to points 51 and 57, the other ends of the switches are shown connecting to ground. As used herein, the “ground” for such switches may be an RF ground or may have a small RF signal swing associated with it. Shunt switches according to the invention are most preferably RF switches in which one end of the switch may be coupled to an RF signal and the other end of the switch is coupled to the ground, in other words a point that has little or no RF signal swing. Thus, when the shunt switch is in a low resistance state (typically a low impedance or “closed” state), both ends of the switch will have little or no RF signal swing. In operation, signal swings less than the operating breakdown voltage limit of the switch, and preferably significantly less than the operating breakdown voltage limit of the switch, may be acceptable.

Now the operation of the shunt switches 50 and 56 during receive and transmit modes will be explained. During receive mode, the antenna 44 will input power from a received signal into the circuit 40. For efficient transceiver operation, it is most desirable for the transmit side 41 of the circuit 40 (e.g., PA section 42, reactive devices 48 and 52, and shunt switch 50) to reflect as much power back toward the antenna 44 as possible. Conversely, it is most desirable for the receive side 43 of the circuit 40 (e.g., LNA section 42, reactive devices 54 and 58, and shunt switch 56) to pass through as much power as possible from the antenna 44. Thus, it is most preferable for the shunt switch 50 of the transmit side 41 to be set in a low impedance state while the shunt switch 56 is set in a high impedance state during receive mode. By way of example only, the shunt switch 50 may be logically “closed” to achieve the low impedance state (e.g., such as can be modeled with a small resistor) and the shunt switch 56 may be logically “opened” to achieve the high impedance state (e.g., such as can be modeled by a small capacitor, as many switches appear capacitive in a high impedance state).

During transmit mode it is most desirable for the receive side 43 to reflect as much power toward the antenna 44 as possible, while it is most desirable for the transmit side 41 to pass through as much power as possible from the PA section 42 to the antenna 44. Thus, in this case, the shunt switch 56 may be logically closed to achieve the low impedance state while the shunt switch 50 may be logically open to achieve the high impedance state. Here, during transmit, the shunt switch 50 must be able to withstand the full RF+DC voltage swing at its terminal connected to node 51 while in a logically open state, while the shunt switch 56 is protected from a large voltage swing by having both of its terminals at a voltage near or at ground. For example, switch 56 can be implemented using a very low breakdown voltage MOS device while switch 50 may require the use of a high breakdown voltage BJT switch.

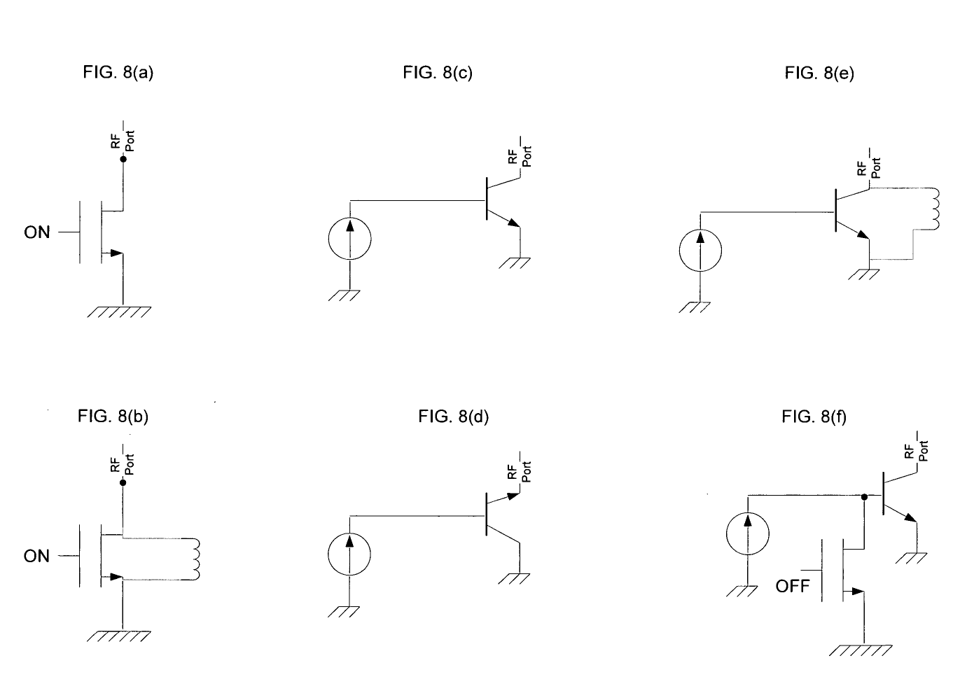

For either shunt switch 50 or shunt switch 56, when the low impedance state is entered, it is desirable to reflect as much power as possible. Thus, while a reflection of 75-80% of power is acceptable, most preferably at least 90% or more of the power is reflected during the low impedance state. The exact degree to which power is reflected is a function of the impedance of the switch in the low impedance state and the specific reactive networks connecting the switch to the antenna node. Conversely, when either shunt switch 50 or shunt switch 56 is in the high impedance mode, it is desirable to dissipate as little power in the switch as possible as the goal in the open state is to transfer as much of the power as possible from the antenna to the selected module (42 or 46). It is possible to increase power transmission by increasing the impedance presented by the switch in its off state at the desired RF signal frequencies. Thus, as shown in FIG. 8(b), an inductor is placed across the transistor to resonate with the output capacitance of the switch in the high resistance state. This may be employed to increase the impedance of the switch within a particular operating frequency range. Similarly, FIG. 8(e) illustrates that the output capacitance of a BJT switch in a high resistance state can also be resonated with an inductor in order to increase the high resistance state output impedance and hence increase the power transmission.

FIG. 1(b) illustrates a general architecture for a transceiver switching circuit 40′ for use in a multi-band (dual frequency) system. The circuit 40′ includes a pair of transceiver circuits 40₁ and 40₂, which are similar to the circuit 40 described above. For instance, circuit 40₁ includes a transmit side 41₁ having a power amplifier section 42₁ electrically coupled to the antenna 44 through the reactive devices 48₁, and 52₁ and shunt switch 50₁. The circuit 40₁ also includes receive side 43₁ having a low noise amplifier section 46₁ that is coupled as well to both the antenna 44 and the user device. The LNA section 46₁ electrically couples to the antenna 44 through the reactive devices 54₁ and 58₁ and shunt switch 56₁. Reactive device 60₁ is also preferably electrically coupled between the transmit and receive sides and the antenna 44.

Similarly, circuit 40₂ includes a transmit side 41₂ having a power amplifier section 42₂ electrically coupled to the antenna 44 through the reactive devices 48₂ and 52₂ and shunt switch 50₂. The circuit 40₂ also includes receive side 43₂ having a low noise amplifier section 46₂ that is coupled as well to both the antenna 44 and the user device. The LNA section 46₂ electrically couples to the antenna 44 through the reactive devices 54₂ and 58₂ and shunt switch 56₂. Reactive device 60₂ is also preferably electrically coupled between the transmit and receive sides and the antenna 44. Here, the reactive devices 60₁ and 60₂ may be configured as frequency diplexers to optimize operation of the circuits 40₁ and 40₂ at two different frequencies or frequency bands.

Thus, two transceivers can operate on two different frequency bands. Each circuit 40₁ and 40₂ preferably operates in the same manner as circuit 40 of FIG. 1(a). For instance, if the circuit 40′ is receiving signals at a first frequency or frequency band, the circuit 40₁ may operate in receive mode. Here, during receive mode, the antenna 44 will input power from a received signal into the circuit 40₁, preferably with the reactive device 60₂ reflecting power away from the circuit 40₂ and toward the antenna 44. For efficient transceiver operation, it is most desirable for the transmit side 41₁ of the circuit 40₁ to reflect as much power back toward the antenna 44 as possible. Conversely, it is most desirable for the receive side 43₁ of the circuit 40₁ to pass through as much power as possible from the antenna 44 to the LNA 46₁. Thus, it is most preferable for the shunt switch 50₁ of the transmit side 41₁ to be set in a low impedance state while the shunt switch 56₁ is set in a high impedance state during receive mode. And both shunt switch 56₂ and 50₂ should be in the low impedance state so that whatever power is passed through 60₂ is reflected back toward the antenna, 44.

During transmit mode at the first frequency or frequency band, it is most desirable for the receive side 43₁ to reflect as much power toward the antenna 44 as possible, which it is most desirable for the transmit side 41₁ to pass through as much power as possible from the PA section 42₁ to the antenna 44. Thus, in this case, the shunt switch 56₁ may be logically closed to achieve the low impedance state while the shunt switch 50₁ may be logically open to achieve the high impedance state. Here, during transmit, the shunt switch 50₁ must be selected to handle the full transmit voltage swing at node 51₁, while the shunt switch 56₁ is protected from the large voltage swing by shunting node 57₁ to ground. It should be understood that operation of the circuit 40₂ at a second frequency or frequency band occurs in similar fashion to that of circuit 40₁ at the first frequency/band. In this case it is preferable for the reactive device 60₁ to reflect power away from the circuit 40₁ and toward the antenna 44, while the reactive device 60₂ admits power to and from the circuit 40₂. In sum, the shunt switches on the paths leading to all of the non-selected (inactive) modules are preferably placed into a low resistant state while the switch on the path leading to the selected (active) module is placed in a high impedance state. The respective reactive devices should be selected to maximize power transfer between the antenna and the particular modules for the active and inactive states.

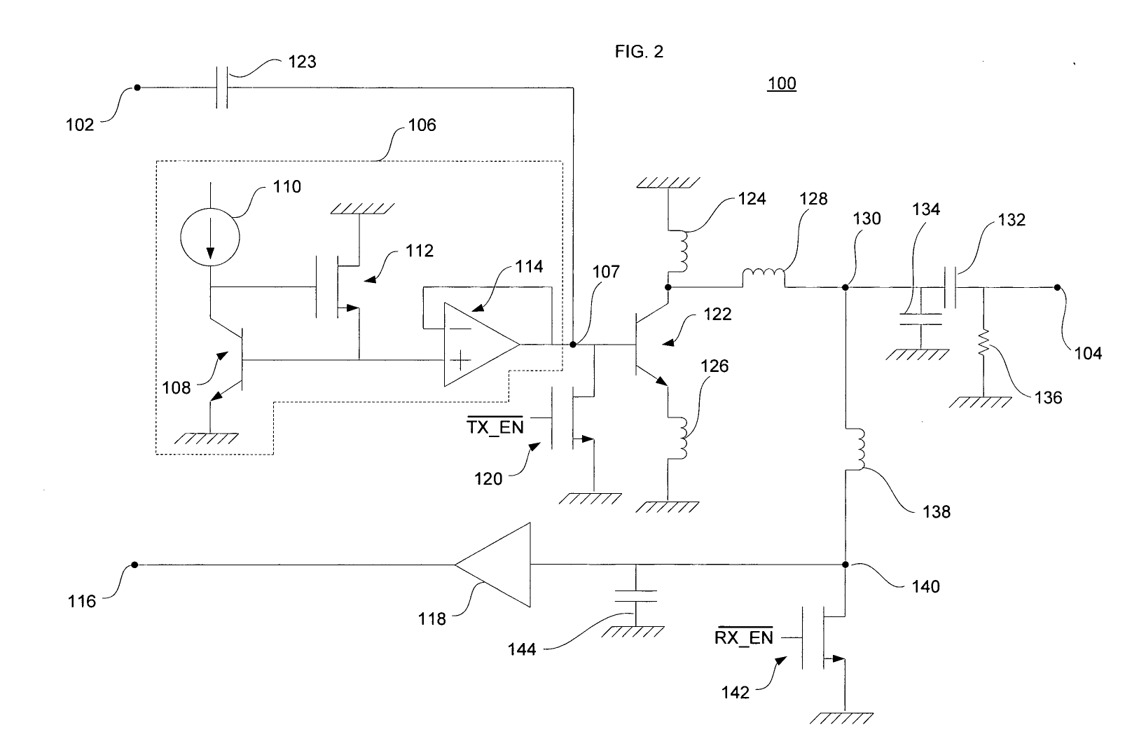

FIG. 2 illustrates a transceiver switching circuit 100 in accordance with another preferred embodiment of the present invention. In this case, the need to have a shunt switch that can withstand the transmit voltage swings seen at node 51 in FIG. 1(a) is avoided by moving the transmit side shunt switch from the output side of the power amplifier final transistor to the input side of the final power amplifier transistor. This dramatically reduces the voltage breakdown requirement of the shunt switch. Here, a first node 102 couples a user device (not shown) to an antenna node 104, which couples either to an antenna or to a frequency multiplexer such as a diplexer (not shown). The antenna node 104 may couple to the antenna or the frequency multiplexer either directly or indirectly. The first node 102 receives signals from the user device that are to be transmitted via the antenna. Prior to transmission, the signals are passed from the first node 102 to a power amplifier 106. The power amplifier 106 acts to boost the strength of the signal that will be output by the antenna.

As shown in the figure, the power amplifier 106 may include a base bias generator, including a reference transistor 108 coupled to a current source 110, a MOS transistor 112, and an operational amplifier 114. The base bias generator is used to bias BJT transistor 122, which is the principal output device of the power amplifier. While an exemplary configuration of power amplifier is provided, the invention is not limited to any particular power amplifier configuration. In this case, instead of having a switch at node 51 as in FIG. 1(b), the NMOS switch, 120 is preferably placed at the base of the power transistor, 122. During transmit mode, switch 120 is in its high impedance state. Although the drain of switch 122 must still withstand the DC+RF signal swing at that node, the RF swing is quite small as BJT 122 has a high voltage gain. During receive mode, switch 120 is placed in its low resistance state. This effectively shorts the base of transistor 122 to ground. To first order, this creates a high RF impedance at the collector of BJT 122 during receive mode. The high impedance at the collector side of the BJT 122 results in most of the RF energy being reflected back toward the receive circuit, e.g., inductor 138, LNA 118, capacitor 144 and switch 142. Regardless of the exact power amplifier configuration, the power amplifier is desirably implemented using a BiCMOS or CMOS IC fabrication process. By way of example only, while BJT and MOS transistors are shown in a particular configuration, these devices may be interchanged, all BJTs may be used, all MOS transistors may be used, etc.

A second node 116 is also coupled to the antenna node 104. The second node 116 is adapted to take signals received by the antenna and provide them to the user device, where they may be subsequently processed or otherwise employed in the operation of the user device. Between the antenna node 104 and the second node 116 is LNA 118, which amplifies the signals received by the antenna 104 prior to passing them to through the second node 116.

The transceiver switching circuit 100 includes additional components which are electrically coupled between either the power amplifier and the antenna node 104 or between the LNA 118 and the antenna node 104. These components include shunt switches.

For instance, the transmission path between the power amplifier and the antenna node 104 preferably includes a first shunt switch 120 coupled to the input node 107 of the power amplifier final stage transistor 122. The switch 120 may be, e.g., a MOS type switch where the drain is coupled to the power amplifier output node, the gate is coupled to a transmit enable (“ T̅X̅_̅E̅N̅”) signal line, and the source is coupled to an RF ground. Alternatively, the switch 120 may be a BJT type or other MOS-based device so long as the switch 120 shunts to ground as explained above. Preferred shunt switch examples are provided in FIGS. 8(a)-(f).

In particular, FIGS. 8(a)-8(f) illustrate different ways to implement shunt switches in the embodiments of the present invention. While examples of shunt switches such as in FIGS. 2-6 illustrate NMOS transistors, there a many possible variations that may be employed in the invention. For instance, FIG. 8(a) illustrates an NMOS transistor for use as a shunt switch. Here, the switch has a low resistance to ground when the gate voltage is well above the threshold voltage of the transistor. Note PMOS transistors (not shown) can be used for switches as well. Also, any parallel combination of switches can be used to generate the switch function.

As explained above, FIG. 8(b) illustrates the use of an inductor to resonate with the output capacitance of the switch in the high resistance state. This technique can be used to increase the off impedance of the switch at in a particular operating frequency range. FIG. 8(c) illustrates an NPN BJT whose base is driven by a current source to turn it on to the low resistance state and whose base is open circuited to put it into the high resistance state. Here, in order to operate as a low resistance switch, the current in the low resistance state must be sufficient to cause the BJT to enter the saturation operating regime. FIG. 8(d) illustrates that in order to reduce the high impedance state output capacitance of the switch, it can be operated in reverse saturation instead of forward saturation as shown in FIG. 8(c).

FIG. 8(e) shows that the output capacitance of the BJT in the high resistance state can also be resonated with an inductor in order to increase the high resistance state output impedance. And FIG. 8(f) illustrates the addition of a shunt NMOS switch at the base of a BJT switch in order to provide for much faster switching from the low resistance state to the high resistance state. Any or all of these shunt switch configurations may be employed with any of the embodiments of the present invention.

Returning to FIG. 2, the transistor 122, such as a BJT, is preferably coupled to the node 107 and a capacitor 123 may be electrically coupled between the first node 102 and the power amplifier's output node as shown.

Inductor 124, which may be used as a “choke,” preferably couples the collector of the transistor 122 to the power source, and inductor 126 preferably couples the emitter of the transistor 122 to ground. The transistor 122's collector (or drain if a MOSFET transistor is used) is also desirably coupled to one end of inductor 128, while the other end of the inductor 128 is coupled to node 130. A capacitor 132, which may be used as a DC block, is preferably disposed between the node 130 and the antenna node 104. A capacitor 134 may also be coupled between the node 130 and ground, while a resistance 136, such as a 50Ω resistance, either may be coupled between the antenna node 104 and ground or may simply represent the load of the antenna at the node 104.

As mentioned above, additional circuitry may be electrically disposed between the antenna node 104 and the LNA 118. In the present embodiment, such circuitry includes an inductor 138 coupled between node 130 and node 140. A second shunt switch 142 is also coupled to the node 140. The switch 142 may be, e.g., a MOS switch where the drain is coupled to the node 140, the gate is coupled to a receive enable (“ R̅X̅_̅E̅N̅”) signal line, and the source is coupled to RF ground. Alternatively, the switch 142 may be a BJT or other MOS-based transistor device so long as the switch 120 shunts to ground. A capacitor 144 preferably also has a first end connected to the node 140 and the LNA 118, while its other end is coupled to ground.

In the present embodiment, when the circuit 100 is to receive a signal from the antenna, the shunt switch 120 is preferably activated to be in a low impedance or logical “on” state, coupling the node 107 to ground. Thus, the base of transistor 122, which would be the gate if a MOS transistor is used instead, is also shorted to ground, and the transmit side of the transceiver circuit 100 reflects power back toward node 130 because the transistor 122 is a high impedance when in the OFF state.

In this case, the portion of the received signal from the antenna that flows through inductor 128 is reflected by the large impedance mismatch between the antenna impedance and the impedance of the base-collector (or drain-gate) capacitance of the transistor 122 in series with the matching capacitor 134. The input impedance looking into inductor 128 from the antenna node 104 is reasonably high as long as the transistor 122 collector capacitance is sufficiently small. Therefore, very little current, and hence little power, will flow from the antenna through inductor 128.

During receive mode, the switch 142 is preferably placed in a logical off state, acting as an open circuit and providing high impedance. Thus, the signal received by the antenna is coupled through an impedance matching network, including inductor 138 and capacitor 144, to the LNA 118, where it is amplified and passed to the node 116. The capacitor 144 is desirably selected to have an optimal noise figure and to match the input impedance from the antenna with the LNA 118.

When the circuit 100 is in transmit mode, switch 120 is preferably placed in a high impedance state, acting as an open circuit while in a logical off state. Switch 142 is preferably placed in a low impedance state, acting as a short circuit while in a logical on state. With switch 120 in high impedance mode, current desirably flows through capacitor 123 to the input of the power amplifier transistor 122, is amplified by the transistor 122, and is coupled to the antenna node 104 through inductor 128, and capacitors 134 and 132. With the switch 142 in low impedance mode, the inductor 138 becomes part of the impedance matching network for the power amplifier 106 that includes inductor 128 and capacitor 134. No excessive, damaging voltage appears across switch 120 or switch 142 during transmit mode due to their shunt configurations and because switch 120 is ahead of high gain transistor 122, thereby ensuring a highly reliable circuit.

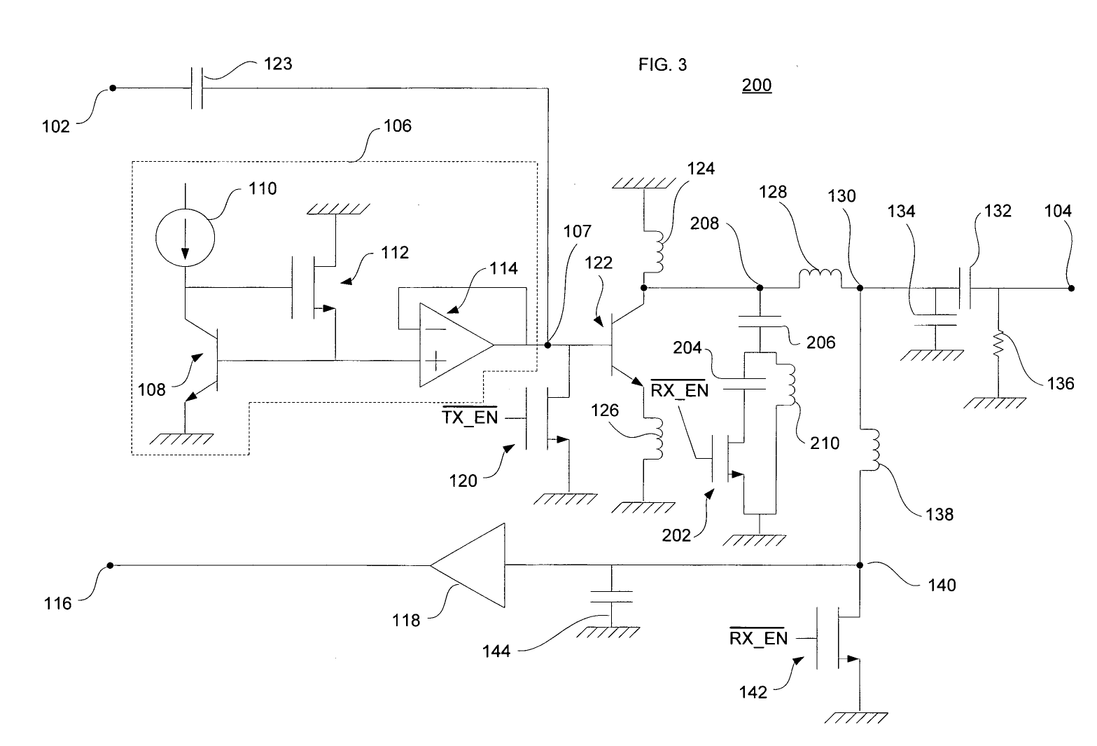

FIG. 3 illustrates another embodiment of the present invention. Here, transceiver switching circuit 200 is a modification of the circuit 100 of FIG. 2. The circuit 200 enables the system designer additional degrees of freedom when selecting particular components, as it decreases the dependence of the design on the particular type of power transistor used. The main differences from circuit 100 will be discussed below.

As shown in FIG. 3, the circuit 200 includes an additional shunt switch, namely switch 202, which is preferably coupled at the drain to capacitor 204, at the source to ground, and at the gate to the receive enable signal line. The primary purpose of the circuit in FIG. 3 is to continue to have all switches avoid high voltage stresses as for the circuit in FIG. 2, but to keep RF signal away from the potentially lossy power transistor 122. This is achieved in the embodiment of FIG. 3 by using a reactive shunt network to short out the RF signal before it can flow into the collector of transistor 122. The capacitor 204 is coupled to node 208 through capacitor 206. The inductor 210 is also coupled to node 208 through the capacitor 206. In an alternative configuration, the capacitor 206 may be disposed between the source of switch 202 and ground.

Regardless of which configuration is used, the structure of FIG. 3 operates as follows. In receive mode, the switch 202 is placed in a high impedance state and the inductor 210 and capacitor 206 are preferably selected to series resonate at the desired receive frequency. The series resonance of inductor 210 and capacitor 206 creates a low impedance in the RF branch of the transmitter. Here, inductor 128 and capacitor 134 are preferably designed to resonate together at the receive frequency. Thus, all of the received signal energy from the antenna port 104 will flow into the matching network for LNA 118, which includes inductor 138 and capacitor 144.

When switching into transmit mode, a possible short circuit at the power amplifier device output could occur, preventing proper operation of the circuit 200. In order to avoid this, the switch 202 is placed in a low impedance state, which creates a parallel resonant circuit with capacitor 204 across inductor 210 that results in the overall impedance from node 208 to ground being high at the resonant frequency. By choosing capacitor 204 to parallel resonate with inductor 210 at the desired transmit frequency, the impedance seen looking into the branch of capacitor 204, inductor 210 and capacitor 206 will have a high impedance and will not significantly load down the power output device. This circuit achieves the goal of improved direction of the antenna power to the LNA during receive mode while still making sure that all of the shunt switches see a very small voltage during the transmit mode as both switches 202 and 142 are in their low resistance state during transmit mode. In the present embodiment, the circuit 200 is configured to operate across a limited frequency range, in particular the band for which capacitor 206 and inductor 210 are in series resonance and the band for which capacitor 204 and inductor 210 are in parallel resonance.

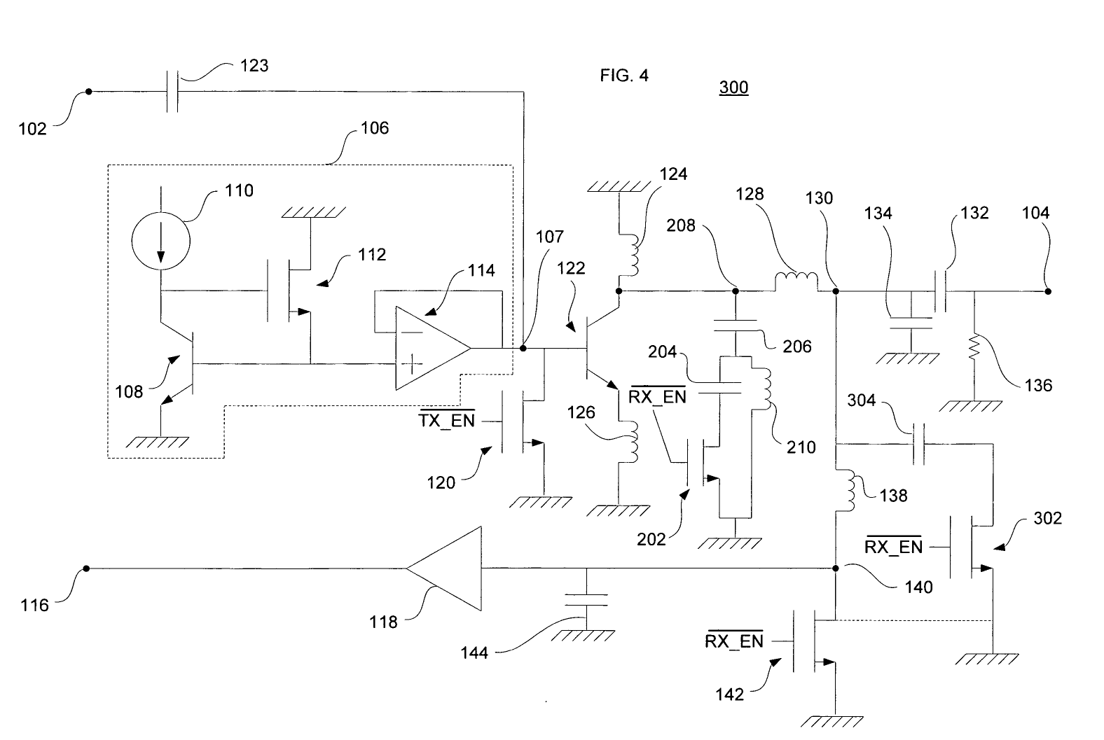

In some situations, an additional degree of freedom is desired in the order to select optimal values for all of the components in both transmit and receive modes. This can be achieved by removing inductor 138 from being a part of the transmission matching network. Another embodiment of the present invention employing such a configuration is shown in FIG. 4, which illustrates transceiver switching circuit 300.

As shown, circuit 300 is similar to circuit 200 and also includes another shunt switch, namely switch 302 in series with capacitor 304. The switch 302 enables modification of the input impedance to a branch through which power should not flow. The capacitor 304 preferably couples the drain of the switch 302 to node 130. The source of the switch 302 may be coupled to ground, or, alternatively as shown by the dotted line, to the drain of switch 142 and node 140. The gate of switch 302 is coupled to the receive enable signal line. As with switches 202 and 142, switch 302 is in the low resistance state during transmit mode and is a shunt switch; therefore none of these three switches will see a high voltage stress even during transmit operation.

Capacitor 304 is desirably selected to resonate in parallel with inductor 138 at the desired transmit frequency. This removes the loading presented by inductor 138 from the transmission matching network, thereby facilitating its optimal design. During receive mode, switch 302 is placed in a high impedance state. During transmit mode, switch 302 is placed in a low impedance state. Neither switch 142 nor switches 302 or 202 will see significant voltages during the transmit mode because they are both in a low impedance state.

In accordance with another aspect of the invention, other reactive devices may be used in the power amplifier output matching. For example, the pi match, the T match, etc., may be employed. Similarly, additional matching networks can be used at the input to LNA 118. For example, the pi match, the T match, etc., may be employed here as well. See FIGS. 1(c)-1(m) for examples of reactive networks that may be employed. Note that the LNA matching network can be connected to the antenna node 104 with either an inductor or a capacitor and the parallel resonator enable by switch 302 in the embodiment of FIG. 4 could be swapped as well so that a parallel resonant circuit can still be formed.

In accordance with another aspect of the present invention, for all of the places where a resonant circuit (either series or parallel) is formed, the center frequency of that resonant circuit can be adjusted by adding in additional reactive elements with additional switches to move the center frequency of the resonance electronically. Although the bandwidth of the technique is may be constrained to some extent due to the resonant operation, by electronically switching the center frequency it can be extended to cover wider bandwidths. This may also be of particular interest for applications with different transmit and receive frequencies, or which employ multiple bands of transmit and/or receive frequencies.

The antenna port or node can actually be part of a larger circuit. For example, as with the embodiment of FIG. 1(b), the antenna node 104 of the circuits in FIGS. 2-4 could be connected to a frequency diplexer which is then connected to an antenna and to a transceiver operating at a different frequency.

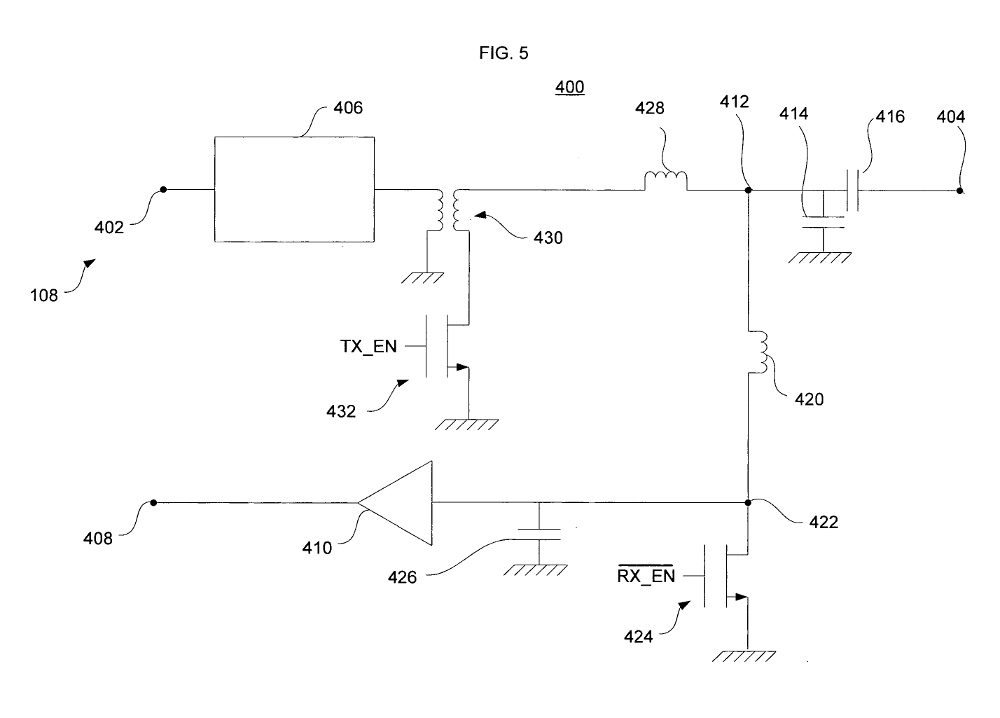

As shown in FIG. 5, additional options become available in a transformer-coupled RF block. This figure illustrates another embodiment of the present invention, namely transceiver switching circuit 400. FIG. 5 illustrates a way to achieve good power reflection in the transmit path while using a shunt switch that is in its low resistance state during transmit mode. As in FIGS. 2-4, a first node 402 couples a user device (not shown) to an antenna node 404, which couples to an antenna or to a frequency multiplexer such as a diplexer (not shown). The antenna node 404 may couple to the antenna or the frequency multiplexer either directly or indirectly. The first node 402 receives signals from the user device that are to be transmitted via the antenna. Prior to transmission, the signals are passed from the first node 402 to a power amplifier 406, which may be of the same configuration as the power amplifier 106.

Similar to the embodiments described above, the circuit 400 also includes a second node 408 coupled to the antenna node 404. The second node 408 is adapted to take signals received by the antenna and provide them to the user device, where they may be subsequently processed or otherwise employed in the operation of the user device. Between the antenna node 404 and the second node 408 is LNA 410, which amplifies the signals received by the antenna 404 prior to passing them to through the second node 408.

Also shown in FIG. 5 is node 412, which is coupled to the antenna node 404 through capacitor 416. The capacitor 416 may be used as a DC block. The capacitor 414 may be coupled between the node 412 and ground as part of an impedance conversion network with inductor 428 and 420.

As in the embodiments of FIGS. 2-4, additional circuitry may be electrically disposed between the antenna node 404 and the LNA 410. In the present embodiment, such circuitry includes an inductor 420 coupled between node 412 and node 422. A shunt switch 424 is also coupled to the node 422. The switch 422 may be, e.g., a MOS switch where the drain is coupled to the node 422, the gate is coupled to the receive enable signal line, and the source is coupled to RF ground. Alternatively, as in the embodiments described above, the switch 424 may be a BJT or other MOS-based transistor device so long as the switch 120 shunts to ground. The switch 424 operates similar to the switch 142 discussed above. A capacitor 426 preferably also has a first end connected to the node 422 and the LNA 410, while its other end is coupled to ground.

The circuit 400 of FIG. 5 also preferably includes an inductor 428 that functions similarly to the inductor 128 described above. One end of the inductor 428 is connected to the node 412, while the other end of the inductor 428 is connected to transformer 430. As shown, one side of the transformer 430 is preferably coupled to shunt switch 432 as well as the inductor 428, while the other side of the transformer 430 is preferably coupled to the power amplifier 406. In this configuration, the drain of the switch 432 is desirably coupled to the transformer 430, the source is desirably coupled to RF ground, and the gate is desirably coupled to the transmit enable signal line. While not shown in the figure, it is also possible to employ a transformer coupled to a shunt switch in the receive path.

In circuits where the RF block to be switched has a transformer at its output, instead of a series switch, the connection of the transformer to RF ground may be broken as shown in FIG. 5. During receive mode, power is reflected away from the power amplifier 406 and toward the node 412 by placing the shunt switch 432 in a high resistance state. With switch 432 at high impedance, current cannot flow through the right hand side of the transformer 430. Therefore, there cannot be coupling of the signal from the antenna node 404 to the left hand side of the transformer 430. Hence, the signal power is reflected back toward the antenna node 404 due to this effective “open circuit.” Note, unlike the technique described in FIG. 3, the approach described in FIG. 5 is broad band in nature. However, if there is too much capacitance at the transformer side of shunt switch 432 when it is in the high resistance state, there may be some power lost from the LNA and coupled through the transformer to the PA, 206. This loss can be decreased with in a specified frequency range by adding an inductor in parallel with the switch that resonates with the switch capacitance in the high resistance state to create a higher impedance at that node as shown in FIG. 8(b) and FIG. 8(e). Conversely, during transmit mode, the shunt switch 432 should be driven in a low resistance state. RF current can then flow efficiently through the transformer 430 toward the antenna node 404. When the RF block is a power amplifier that generates very large voltage swings at the output of transformer 430, this arrangement has the advantage that the switch 432 is in its low resistance state when high voltages signals are flowing from the power amplifier 406 to the antenna node 404, but no significant voltage appears across the switch 432 that could cause breakdown of the device.

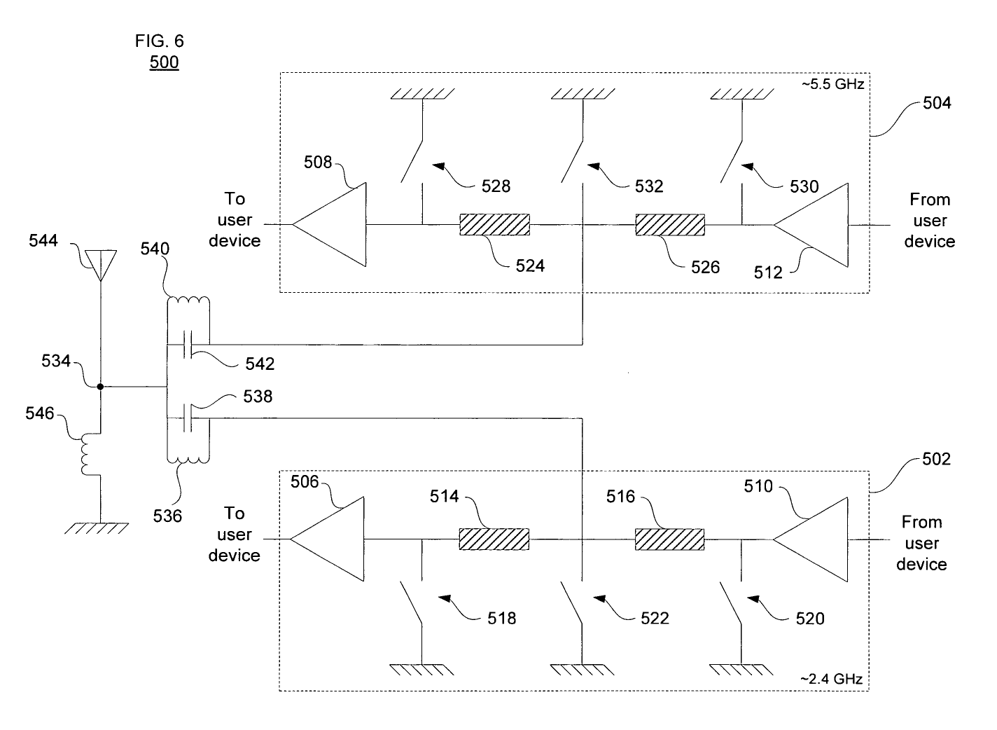

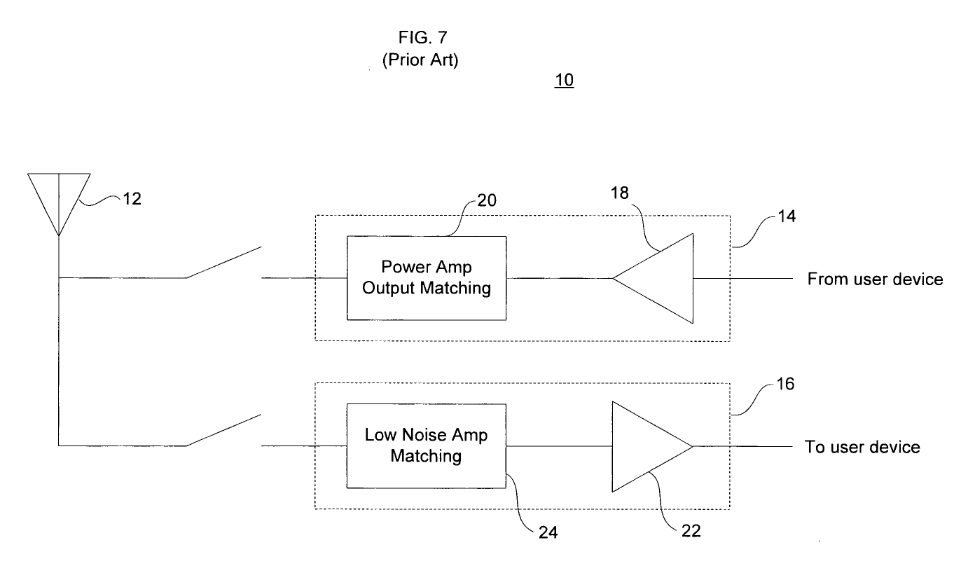

FIG. 6 illustrates yet another embodiment of the present invention, which is similar to the example provided in FIG. 1(b). Transceiver switching circuit 500 is especially adapted for use with multiple transmit and receive bands.

In particular, FIG. 6 illustrates extending the use of on-chip shunt switches to an exemplary case where one of two possible transmit stages or one of two possible receive stages is connected to a single antenna or port. In a preferred example, the circuitry is configured to support 802.11 signals which are either at approximately 2.4 GHz (for 802.11b or 802.11g) or between 4.9 GHz and 5.85 GHz, such as on the order of 5.5 GHz (for 802.11a). In this case, it is most preferable to have separate power amplifiers for each transmit band and separate LNAs for each receive band.

As shown, the circuit 500 includes a first section 502 adapted for the 2.4 GHz band of the 802.11b and g standards and a second section 504 adapted for the 4.9-5.85 GHz band for the 802.11a standard. Each of the sections 502 and 504 includes an LNA, namely LNA 506 for section 502 and LNA 508 for section 504, where the LNAs 506 and 508 are adapted for operation at the respective frequency band. Each of the sections 502 and 504 preferably also includes a power amplifier, namely power amplifier 510 for section 502 and power amplifier 512 for section 504. As with the LNAs 506 and 508, the power amplifiers 510 and 512 are preferably adapted for operation at the respective frequency band.

The section 502 preferably also includes a reactive network of elements 514 and 516 in conjunction with switches 518, 520 and 522. The elements 514 and 516 may comprise, by way of example only, quarter wavelength transmission lines or pseudo quarter wavelength lines (ones approximated by a finite number of inductors and capacitors). In one example, the elements 514 and 516 comprise pi or tee LC lumped networks. Other examples of reactive networks which may be employed are illustrated in FIGS. 1(c)-1(m). The switches 518, 520 and 522 are most preferably shunt switches, where the shunt switch 518 is for activating/deactivating the LNA 506, the shunt switch 520 is for activating/deactivating the power amplifier 510, and the shunt switch 522 is for activating/deactivating the first section 502 generally. Examples of such shunt switches are provided in FIGS. 8(a)-8(f).

The section 504 preferably also includes a reactive network of elements 524 and 526 in conjunction with switches 528, 530 and 532. As with elements 514 and 516, the elements 524 and 526 may comprise, by way of example only, pseudo quarter wavelength lines. In one example, the elements 524 and 526 comprise pi or tee LC lumped networks, although other reactive networks such as in FIGS. 1(c)-1(m) may be employed. The switches 528, 530 and 532 are most preferably shunt switches, where the shunt switch 528 is for activating/deactivating the LNA 508, the shunt switch 530 is for activating/deactivating the power amplifier 512, and the shunt switch 532 is for activating/deactivating the second section 504 generally. As above, examples of such shunt switches are provided in FIGS. 8(a)-8(f).

As shown in FIG. 6, the first section 502 couples to antenna node 534 through inductor 536 and capacitor 538, which are in parallel with each other. Similarly, the second section 504 couples to the antenna node 534 through inductor 540 and capacitor 542, which are in parallel with each other. These two LC networks are preferably employed for frequency selective filtering as a frequency diplexer. Specific values for the inductors 536 and 540 and capacitors 538 and 542 may are chosen based upon the frequency bands of sections 502 and 504. Preferably, the inductor 540 and capacitor 542 are selected to resonate at the frequency of operation of section 502, while the inductor 536 and capacitor 538 are selected to resonate at the frequency of operation of section 504. One end of the node 534 couples to antenna 544, while the other end couples to ground via inductor 546. While not required, the inductor 546 may be employed to help combat electrostatic discharge and to help reflect low frequency signals.

During operation, one power amplifier or one LNA of the circuit 500 is preferably active at a time. The other active components are preferable placed in a state to reflect power away from them. This is done using the shunt switches. By way of example only, if the circuit 500 is to receive a signal in the 2.4 GHz band, switches 520, 528, 530 and 532 are preferably placed in a low impedance state so that most or all of the power is reflected away from PA 510, PA 530 and LNA 508. Here, the shunt switches 518 and 522 are preferably placed in a high impedance state so that most or all of the power passes from the antenna 544 to the LNA 506.

In another example, if the circuit 500 is to transmit a signal in the 5.5 GHz band, switches 518, 520, 522 and 528 are preferably placed in a low impedance state so that most or all of the power is reflected away from the PA 510, the LNA 506 and the LNA 508. Here, the shunt switches 530 and 532 are preferably placed in a high impedance state so that most or all of the power passes from the PA 512 to the antenna 544.

Thus, it can be seen that FIG. 6 illustrates one preferred combination of reactive networks and shunt switches that allows any of the 4 RF modules (the two LNAs and the two power amplifiers) to be connected to the antenna 544 or node 534 while the other modules are disconnected.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. By way of example only, while MOS switches may be illustrated in the figures for certain embodiments, BJT or diode switches may be employed instead. In addition, while the circuits presented above were described in a single-ended configuration, the invention is not so limited and is equally applicable to differential configurations as well. Furthermore, any of the embodiments according to the present invention are preferably implemented in single chip architectures. As discussed above, features in the embodiments described herein may be incorporated into other embodiments. For instance, any of the reactive networks may be used in any of the embodiments herein. Similarly, any of the shunt switch configurations may be used in any of the embodiments herein.

1. A transceiver module comprising:
an antenna node;
a transmit path electrically connected to the antenna node, the transmit path comprising a power amplifier;
a receive path electrically coupled to the antenna node, the receive path comprising a low noise amplifier; and
at least one switchable impedance comprising a switch electrically coupled to the transmit path and the receive path, wherein the switchable impedance is configured to switch between a first state that substantially reflects power in the transmit path from the antenna node and a second state that substantially reflects power in the receive path from the antenna node and wherein the switch is a silicon based shunt switch coupled to ground and is selected from the group consisting of a silicon-based MOS switch, a silicon-based bipolar switch and a silicon-based diode and wherein the transceiver module is formed on a single, unitary substrate.

2. The transceiver of claim 1, wherein the at least one switchable impedance comprises a switchable impedance in the transmit path and a switchable impedance in the receive path, and wherein both the transmit path switch and the receive path switch are silicon based shunt switches coupled to ground.

3. The transceiver of claim 2 wherein the receive path switch is coupled between a node on the receive path and ground and the transmit path switch is coupled between a node on the transmit path and ground.

4. The transceiver of claim 3 wherein the receive path switch and the transmit path switch are configured such that, when in the low resistance state, there is a switch signal swing that is less than a switch operating breakdown voltage limit.

5. The transceiver of claim 3 wherein the receive path switch and the transmit path switch are configured such that, when in the low resistance state, there is a switch signal swing that is substantially zero.

6. The transceiver of claim 1 further comprising a reactive device electrically coupled to the switch.

7. The transceiver of claim 2 wherein the transceiver is configured to operate in a transmit mode and a receive mode and wherein the switchable impedance in the transmit path has a higher impedance in the transmit mode and a lower impedance in the receive mode and the switchable impedance in the receive path has a higher impedance in the receive mode and a lower impedance in the transmit mode.

8. The transceiver of claim 1 wherein the switchable impedance in the transmit path substantially reflects power in the receive mode away from the power amplifier.

9. The transceiver of claim 1 where the switchable impedance in the receive path substantially reflects power in the transmit mode away from the low noise amplifier.

10. The transceiver of claim 2, wherein the transmit path comprises a plurality of transmit paths each including a respective power amplifier and the receive path comprises a plurality of receive paths each including a respective low noise amplifier.

11. The transceiver of claim 2 wherein the switches are MOS transistors.

12. The transceiver of claim 6 further comprising a first switchable impedance in the transmit path and a second switchable impedance in the receive path, wherein the transmit path switch and the receive path switch are MOS transistors coupled to RF ground and wherein the first switchable impedance is electrically coupled to a first reactive device and the second switchable impedance is electrically coupled to a second reactive device.

13. The transceiver of claim 12 wherein at least one of the MOS transistor has an inductor placed across the transistor wherein the inductor is selected to resonate with an output capacitance of the MOS transistor in the high impedance state.

14. The transceiver of claim 2 wherein the switches are bipolar transistors.

15. The transceiver of claim 14 wherein at least one of the bipolar transistors has an inductor placed across the transistor wherein the inductor is selected to resonate with an output capacitance of the bipolar transistor in the high impedance state.

16. The transceiver of claim 7 wherein the power amplifier further comprises a bipolar junction transistor as an output device and the switchable impedance in the transmit path is a MOS transistor coupled to an input of the power amplifier and input and the base of the bipolar junction transistor.

17. The transceiver of claim 16 wherein the transmit path further comprises a reactive device comprising an MOS transistor electrically coupled to ground and configured to short the RF signal when the switchable impedance in the transmit path is in the high impedance mode.

18. The transceiver of claim 2 wherein the transceiver is configured to operate in a transmit mode and a receive mode and wherein the switchable impedance in the transmit path has a lower impedance in the transmit mode and a higher impedance in the receive mode and switchable impedance in the receive path has a higher impedance in the receive mode and a lower impedance in the transmit mode.

19. The transceiver of claim 18 wherein the transmit path further comprises a transformer coupled to the switchable impedance wherein the switchable impedance is in the high impedance state in the receive mode and the low impedance state in the transmit mode.

20. The transceiver of claim 18 wherein the transmit path further comprises a reactive element connecting the transmit path to ground and having a low impedance at a predetermined frequency when the switchable impedance is in a low impedance state and a high impedance at the predetermined frequency when the switchable impedance is in a high impedance state.

21. The transceiver of claim 18 wherein the switchable impedances are selected from the group consisting of MOS transistors, bipolar transistors and combinations of MOS transistors and bipolar transistors.

22. A transceiver module comprising:
an antenna node;
a transmit path electrically connected to the antenna node, the transmit path comprising a power amplifier;
a receive path electrically coupled to the antenna node, the receive path comprising a low noise amplifier;
at least one switchable impedance means comprising switch means electrically coupled to the transmit path and the receive path, wherein the switchable impedance means is configured to switch between a first state that substantially reflects power in the transmit path from the antenna node and a second state that substantially reflects power in the receive path from the antenna node, and wherein the transceiver module is formed on a single, unitary substrate.

23. The transceiver of claim 22, wherein the at least one switchable impedance means comprises switchable impedance means having a first switch means in the transmit path and switchable impedance means having a second switch means in the receive path.

24. The transceiver of claim 22, further comprising a reactive element means electrically coupled to the switch means.

25. The transceiver of claim 23 wherein the transceiver is configured to operate in a transmit mode and a receive mode and wherein the switchable impedance means in the transmit path has a higher impedance in the transmit mode and a lower impedance in the receive mode and the switchable impedance means in the receive path has a higher impedance in the receive mode and a lower impedance in the transmit mode.

26. The transceiver of claim 23, wherein the transmit path comprises a plurality of transmit paths each including a respective power amplifier and the receive path comprises a plurality of receive paths each including a respective low noise amplifier.

27. The transceiver of claim 26, further comprising a first switchable impedance means in the transmit path and a second switchable impedance means in the receive path, wherein the first switchable impedance means is electrically coupled to a first reactive element means and the second switchable impedance means is electrically coupled to a second reactive element means.

28. The transceiver of claim 23, wherein the transceiver is configured to operate in a transmit mode and a receive mode and wherein the switchable impedance means in the transmit path has a lower impedance in the transmit mode and a higher impedance in the receive mode and switchable impedance means in the receive path has a higher impedance in the receive mode and a lower impedance in the transmit mode.

29. The transceiver of claim 28, wherein the transmit path further comprises a transformer coupled to the switchable impedance means and wherein the switchable impedance means is in the high impedance state in the receive mode and the low impedance state in the transmit mode.

30. The transceiver of claim 28, wherein the transmit path further comprises a reactive element means connecting the transmit path to ground and having a low impedance at a predetermined frequency when the switchable impedance is in a low impedance state and a high impedance at the predetermined frequency when the switchable impedance means is in a high impedance state.

31. A transceiver module comprising:
an antenna node;
a frequency multiplexer coupled to the antenna node; and
a plurality of transceivers each coupled to the antenna node via the frequency multiplexer wherein each transceiver is configured to operate at a separate frequency and wherein each transceiver comprises:
a transmit path electrically connected to the antenna node, the transmit path comprising a power amplifier and at least one switchable impedance; and
a receive path electrically coupled to the antenna node, the receive path comprising a low noise amplifier and at least one switchable impedance;
wherein each switchable impedance is configured to switch between a first state that substantially reflects power back toward the antenna node and a second state in which signal power is transmitted along its respective path and comprising a switch, wherein the switch is a silicon based shunt switch coupled to ground and is selected from the group consisting of a silicon-based MOS switch, a silicon-based bipolar switch and a silicon-based diode and wherein the transceiver module is formed on a single, unitary substrate.

32. A transceiver module comprising:
an antenna node;
a transmit path electrically connected to the antenna node, the transmit path comprising a power amplifier, a transformer coupled to the power amplifier, and a switchable impedance coupled to the transformer, wherein the switchable impedance is in a high impedance state in a first mode of operation that is a receive mode and is in a low impedance state in a second mode that is a transmit mode; and
a receive path electrically coupled to the antenna node, the receive path comprising a low noise amplifier and a switchable impedance that is in a high impedance state in the receive mode and a low impedance state in the transmit mode;
each switchable impedance comprising a silicon based shunt switch coupled to ground and is selected from the group consisting of a silicon-based MOS switch, a silicon-based bipolar switch and a silicon-based diode and wherein the transceiver module is formed on a single, unitary substrate.
